(19) United States
(12) Patent Application Publication
(10) Pub. No.: US 2011/0091805 A1
(43) Pub. Date: Apr. 21, 2011

(54) TONER COMPOSITIONS

(75) Inventors: Maria N.V. McDougall, Oakville (CA); Richard P.N. Veregin, Mississauga (CA); Eric Rotberg, Toronto (CA); Michael S. Hawkins, Cambridge (CA)

(73) Assignee: XEROX CORPORATION, Norwalk, CT (US)

(21) Appl. No.: 12/582,997

(22) Filed: Oct. 21, 2009

(51) Int. Cl. G03G 9/08; G03G 9/09

(52) U.S. Cl. 430/111.41; 430/105

(57) ABSTRACT

Toner particles are provided which may, in embodiments, include an additive package including a titanium dioxide that has been subjected to a fluorine treatment. In embodiments, additional additives, including a silica, optionally in combination with a metal salt of a fatty acid, for example a zinc stearate, may be included. The additives provide toners with excellent charging characteristics and good blocking performance.

### BACKGROUND

The present disclosure relates to toners suitable for electrophotographic apparatuses.

Numerous processes are within the purview of those skilled in the art for the preparation of toners. Micronized toner produced by size reduction is one such method. Emulsion aggregation (EA) is another such method. These toners may be formed by aggregating a colorant with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

Polyester EA ultra low melt (ULM) toners have been prepared utilizing amorphous and crystalline polyester resins and polyester low melt jetted toners have been prepared utilizing amorphous polyester resins. An issue which may arise with these formulations is that the additive packages included in developers possessing such toners might not possess good blocking performance and good fusing properties, which may be desirable for lower energy consumption and higher print speeds.

Improved processes for producing toners remain desirable.

### SUMMARY

The present disclosure provides toners and processes for making same. In embodiments, a toner of the present disclosure may include a resin; an optional colorant; an optional wax; and at least one additive including a titanium dioxide treated with fluorine, with the fluorine being present in an amount of from about 1% by weight of the titanium dioxide to about 20% by weight of the titanium dioxide.

In embodiments, a toner of the present disclosure may include at least one amorphous polyester resin, optionally in combination with at least one crystalline polyester resin; an optional colorant; an optional wax; and at least one additive including a titanium dioxide treated with fluorine, with the fluorine being present in an amount of from about 1% by weight of the titanium dioxide to about 20% by weight of the titanium dioxide, in combination with silica and optionally a metal salt of a fatty acid.

In other embodiments, a toner of the present disclosure may include at least one amorphous polyester resin, optionally in combination with at least one crystalline polyester resin; an optional colorant; an optional wax; and at least one additive including a titanium dioxide treated with fluorine, the fluorine being present in an amount of from about 1% by weight of the titanium dioxide to about 20% by weight of the titanium dioxide, in combination with silica and optionally zinc stearate, wherein the titanium dioxide treated with fluorine is present in an amount of from about 0.2% by weight of the toner to about 3% by weight of the toner.

### BRIEF DESCRIPTION OF THE DRAWINGS

Various embodiments of the present disclosure will be described herein below with reference to the figures wherein:

FIG. 1 is a graph depicting toner charging for a jetted toner having an additive package of the present disclosure compared with a jetted toner having a conventional additive package;

FIG. 2 is a graph depicting relative humidity (RH) sensitivity for a jetted toner having an additive package of the present disclosure compared with a jetted toner having a conventional additive package;

FIG. 3 is a graph depicting toner blocking resistance for ultra low melt emulsion aggregation (EAULM) and jetted toners having an additive package of the present disclosure compared with a conventional additive package.

FIG. 4 is a graph depicting surface additive impaction rate for EAULM and jetted toners possessing an additive package of the present disclosure compared with a conventional additive package;

FIG. 5 is a graph depicting the tribo charge to mass ratio charging for jetted toners possessing an additive package of the present disclosure compared with a conventional additive package;

FIG. 6 is a graph depicting the minimum and maximum charge to diameter mass ratio for the charge distributions of a jetted toner with the additive package of the present disclosure; and

FIG. 7 is a graph depicting hybrid scavengeless development (HSD) wire contamination voltage for jetted toners possessing an additive package of the present disclosure compared with a conventional additive package.

### DETAILED DESCRIPTION

The present disclosure provides developer compositions having excellent fusing properties. The developer compositions include a ULM EA toner in combination with an optimized additive package including a titanium dioxide that has been subjected to a fluorine treatment. In embodiments, the developer compositions include a jetted polyester toner in combination with an optimized additive package including a titanium dioxide that has been subjected to a fluorine treatment. As used herein, a jetted toner includes any toner prepared by micronization of a resin, wherein that resin has other optional ingredients, such as pigment, wax and charge control agents, which may be admixed in the resin by melt-mixing prior to the micronization step.

### Resins

Any latex resin may be utilized in forming a toner of the present disclosure. Such resins, in turn, may be made of any suitable monomer. Any monomer employed may be selected depending upon the particular polymer to be utilized.

In embodiments, the resins may be an amorphous resin, a crystalline resin, and/or a combination thereof. In further embodiments, the polymer utilized to form the resin may be a polyester resin, including the resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol may be, for example, selected in an amount of from about 40 to about 60 mole percent, in embodiments from about 42 to about 55 mole percent, in embodiments from about 45 to about 53 mole percent, and the alkali sulfo-aliphatic diol can be selected in an amount of from about 0 to about 10 mole percent, in embodiments from about 1 to about 4 mole percent of the resin.

Examples of organic diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis,1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid may be selected in an amount of, for example, in embodiments from about 40 to about 60 mole percent, in embodiments from about 42 to about 52 mole percent, in embodiments from about 45 to about 50 mole percent, and the alkali sulfo-aliphatic diacid can be selected in an amount of from about 1 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly (propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), polypropylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount of from about 5 to about 50 percent by weight of the toner components, in embodiments from about 10 to about 35 percent by weight of the toner components. The crystalline resin can possess various melting points of, for example, from about 30° C. to about 120° C., in embodiments from about 50° C. to about 90° C. The crystalline resin may have a number average molecular weight (Mₙ), as measured by gel permeation chromatography (GPC) of, for example, from about 1,000 to about 50,000, in embodiments from about 2,000 to about 25,000, and a weight average molecular weight (M_{w}) of, for example, from about 2,000 to about 100,000, in embodiments from about 3,000 to about 80,000, as determined by Gel Permeation Chromatography using polystyrene standards. The molecular weight distribution (M_{w}/Mₙ) of the crystalline resin may be, for example, from about 2 to about 6, in embodiments from about 3 to about 4.

Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 52 mole percent of the resin, in embodiments from about 45 to about 50 mole percent of the resin.

Examples of diols which may be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and combinations thereof. The amount of organic diol selected can vary, and may be present, for example, in an amount from about 40 to about 60 mole percent of the resin, in embodiments from about 42 to about 55 mole percent of the resin, in embodiments from about 45 to about 53 mole percent of the resin.

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate), copoly(propylene-butylene-terephthalate)-copoly(propylene-butylene-5-sulfo-isophthalate), copoly(propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), wherein the alkali metal is, for example, a sodium, lithium or potassium ion.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

In embodiments, a suitable polyester resin may be an amorphous polyester such as a poly(propoxylated bisphenol A co-fumarate) resin having the following formula (I):

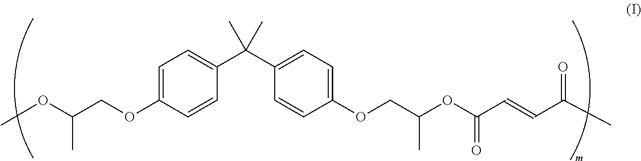

wherein m may be from about 5 to about 1000. Examples of such resins and processes for their production include those disclosed in U.S. Pat. No. 6,063,827, the disclosure of which is hereby incorporated by reference in its entirety.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, N.C., and the like.

Suitable crystalline resins which may be utilized, optionally in combination with an amorphous resin as descried above, include those disclosed in U.S. Patent Application Publication No. 2006/0222991, the disclosure of which is hereby incorporated by reference in its entirety. In embodiments, a suitable crystalline resin may include a resin formed of ethylene glycol and a mixture of dodecanedioic acid and fumaric acid co-monomers with the following formula:

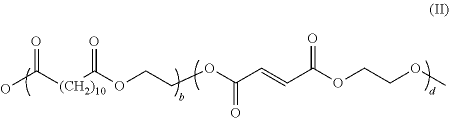

wherein b is from about 5 to about 2000 and d is from about 5 to about 2000.

For example, in embodiments, a poly(propoxylated bisphenol A co-fumarate) resin of formula I as described above may be combined with a crystalline resin of formula II.

In embodiments, the resin may be a crosslinkable resin. A crosslinkable resin is a resin including a crosslinkable group or groups such as a C═C bond. The resin can be crosslinked, for example, through a free radical polymerization with an initiator. Thus, in embodiments, a resin may be partially crosslinked, which may be referred to, in embodiments, as a “partially crosslinked polyester resin” or a “polyester gel”. In embodiments, from about 1% by weight to about 50% by weight of the polyester gel may be crosslinked, in embodiments from about 5% by weight to about 35% by weight of the polyester gel may be crosslinked.

In embodiments, the amorphous resins described above may be partially crosslinked. For example, an amorphous resin which may be crosslinked and used in forming a toner particle in accordance with the present disclosure may include a crosslinked amorphous polyester of formula I above. Methods for forming the polyester gel include those within the purview of those skilled in the art. For example, crosslinking may be achieved by combining an amorphous resin with a crosslinker, sometimes referred to herein, in embodiments, as an initiator. Examples of suitable crosslinkers include, but are not limited to, for example, free radical or thermal initiators such as organic peroxides and azo compounds. Examples of suitable organic peroxides include diacyl peroxides such as, for example, decanoyl peroxide, lauroyl peroxide and benzoyl peroxide, ketone peroxides such as, for example, cyclohexanone peroxide and methyl ethyl ketone, alkyl peroxyesters such as, for example, t-butyl peroxy neodecanoate, 2,5-dimethyl 2,5-di (2-ethyl hexanoyl peroxy) hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, oo-t-butyl o-isopropyl mono peroxy carbonate, 2,5-dimethyl 2,5-di (benzoyl peroxy) hexane, oo-t-butyl o-(2-ethyl hexyl) mono peroxy carbonate, and oo-t-amyl o-(2-ethyl hexyl) mono peroxy carbonate, alkyl peroxides such as, for example, dicumyl peroxide, 2,5-dimethyl 2,5-di (t-butyl peroxy) hexane, t-butyl cumyl peroxide, α-α-bis(t-butyl peroxy) diisopropyl benzene, di-t-butyl peroxide and 2,5-dimethyl 2,5di (t-butyl peroxy) hexyne-3, alkyl hydroperoxides such as, for example, 2,5-dihydro peroxy 2,5-dimethyl hexane, cumene hydroperoxide, t-butyl hydroperoxide and t-amyl hydroperoxide, and alkyl peroxyketals such as, for example, n-butyl 4,4-di (t-butyl peroxy) valerate, 1,1-di (t-butyl peroxy) 3,3,5-trimethyl cyclohexane, 1,1-di (t-butyl peroxy)cyclohexane, 1,1-di (t-amyl peroxy)cyclohexane, 2,2-di (t-butyl peroxy) butane, ethyl 3,3-di (t-butyl peroxy) butyrate and ethyl 3,3-di (t-amyl peroxy) butyrate, and combinations thereof. Examples of suitable azo compounds include 2,2,′-azobis(2,4-dimethylpentane nitrile), azobis-isobutyronitrile, 2,2′-azobis (isobutyronitrile), 2,2′-azobis (2,4-dimethyl valeronitrile), 2,2′-azobis (methyl butyronitrile), 1,1′-azobis (cyano cyclohexane), other similar known compounds, and combinations thereof.

Although any suitable initiator can be used, in embodiments the initiator may be an organic initiator that is soluble in any solvent present, but not soluble in water. For example, half-life/temperature characteristic plots for VAZO® 52 (2,2,′-azobis(2,4-dimethylpentane nitrile), commercially available from E. I. du Pont de Nemours and Company, USA) shows a half-life greater than about 90 minutes at about 65° C. and less than about 20 minutes at about 80° C.

Where utilized, the initiator may be present in an amount of from about 0.5% by weight to about 20% by weight of the resin, in embodiments from about 1% by weight to about 10% by weight of the resin.

The crosslinker and amorphous resin may be combined for a sufficient time and at a sufficient temperature to form the crosslinked polyester gel. In embodiments, the crosslinker and amorphous resin may be heated to a temperature of from about 25° C. to about 99° C., in embodiments from about 40° C. to about 95° C., for a period of time of from about 1 minute to about 10 hours, in embodiments from about 5 minutes to about 5 hours, to form a crosslinked polyester resin or polyester gel suitable for use in forming toner particles.

In embodiments, the resins utilized in forming toner particles may have a glass transition temperature of from about 30° C. to about 80° C., in embodiments from about 35° C. to about 70° C. In further embodiments, the resins utilized in forming toner particles may have a melt viscosity of from about 10 to about 1,000,000 Pa*S at about 130° C., in embodiments from about 20 to about 100,000 Pa*S.

One, two, or more toner resins may be used. In embodiments where two or more toner resins are used, the toner resins may be in any suitable ratio (e.g., weight ratio) such as for instance about 10% (first resin)/90% (second resin) to about 90% (first resin)/10% (second resin).

In embodiments, the resin may be formed by emulsion polymerization methods.

### Toner

The resin described above may be utilized to form toner compositions. Such toner compositions may include optional colorants, waxes, and other additives. Toners may be formed utilizing any method within the purview of those skilled in the art.

### Surfactants

In embodiments, the colorants, waxes, and other additives utilized to form toner compositions may be in dispersions including surfactants. Moreover, toner particles may be formed by emulsion aggregation methods where the resin and other components of the toner are placed in one or more surfactants, an emulsion is formed, toner particles are aggregated, coalesced, optionally washed and dried, and recovered.

One, two, or more surfactants may be utilized. The surfactants may be selected from ionic surfactants and nonionic surfactants. Anionic surfactants and cationic surfactants are encompassed by the term “ionic surfactants.” In embodiments, the surfactant may be utilized so that it is present in an amount of from about 0.01% to about 5% by weight of the toner composition, for example from about 0.75% to about 4% by weight of the toner composition, in embodiments from about 1% to about 3% by weight of the toner composition.

Examples of nonionic surfactants that can be utilized include, for example, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC PE/F, in embodiments SYNPERONIC PE/F 108.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of the cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, and mixtures thereof.

### Colorants

As the colorant to be added, various known suitable colorants, such as dyes, pigments, mixtures of dyes, mixtures of pigments, mixtures of dyes and pigments, and the like, may be included in the toner. The colorant may be included in the toner in an amount of, for example, about 0.1 to about 35 percent by weight of the toner, or from about 1 to about 15 weight percent of the toner, or from about 3 to about 10 percent by weight of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Optionally, a wax may also be combined with the resin and optional colorant in forming toner particles. When included, the wax may be present in an amount of, for example, from about 1 weight percent to about 25 weight percent of the toner particles, in embodiments from about 5 weight percent to about 20 weight percent of the toner particles.

Waxes that may be selected include waxes having, for example, a weight average molecular weight of from about 500 to about 20,000, in embodiments from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents.

### Toner Preparation

The toner particles may be prepared by any method within the purview of one skilled in the art. Although embodiments relating to toner particle production are described below with respect to emulsion-aggregation processes, any suitable method of preparing toner particles may be used, including chemical processes, such as suspension and encapsulation processes disclosed in U.S. Pat. Nos. 5,290,654 and 5,302,486, and extrusion processes with subsequent jetting to form toner particles as disclosed in U.S. Pat. No. 6,850,725, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion-aggregation processes, such as a process that includes aggregating a mixture of an optional colorant, an optional wax and any other desired or required additives, and emulsions including the resins described above, optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. In embodiments, the pH of the mixture may be adjusted to from about 4 to about 5. Additionally, in embodiments, the mixture may be homogenized. If the mixture is homogenized, homogenization may be accomplished by mixing at about 600 to about 4,000 revolutions per minute. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

The aggregating agent may be added to the mixture utilized to form a toner in an amount of, for example, from about 0.1% to about 8% by weight, in embodiments from about 0.2% to about 5% by weight, in other embodiments from about 0.5% to about 5% by weight, of the resin in the mixture. This provides a sufficient amount of agent for aggregation.

In order to control aggregation and subsequent coalescence of the particles, in embodiments the aggregating agent may be metered into the mixture over time. For example, the agent may be metered into the mixture over a period of from about 5 to about 240 minutes, in embodiments from about 30 to about 200 minutes. The addition of the agent may also be done while the mixture is maintained under stirred conditions, in embodiments from about 50 rpm to about 1,000 rpm, in other embodiments from about 100 rpm to about 500 rpm, and at a temperature that is below the glass transition temperature of the resin as discussed above, in embodiments from about 30° C. to about 90° C., in embodiments from about 35° C. to about 70° C.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 30° C. to about 99° C., and holding the mixture at this temperature for a time from about 0.5 hours to about 10 hours, in embodiments from about hour 1 to about 5 hours, while maintaining stirring, to provide the aggregated particles. Once the predetermined desired particle size is reached, then the growth process is halted. In embodiments, the predetermined desired particle size is within the toner particle size ranges mentioned above.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C., which may be below the glass transition temperature of the resin as discussed above.

Once the desired final size of the toner particles is achieved, the pH of the mixture may be adjusted with a base to a value of from about 3 to about 10, and in embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

### Shell Resin

In embodiments, after aggregation, but prior to coalescence, a shell may be applied to the aggregated particles.

Resins which may be utilized to form the shell include, but are not limited to, the amorphous resins described above. In embodiments, an amorphous resin which may be used to form a shell in accordance with the present disclosure may include an amorphous polyester of formula I above.

In some embodiments, the amorphous resin utilized to form the shell may be crosslinked. For example, crosslinking may be achieved by combining an amorphous resin with a crosslinker, sometimes referred to herein, in embodiments, as an initiator. Examples of suitable crosslinkers include, but are not limited to, for example free radical or thermal initiators such as organic peroxides and azo compounds described above as suitable for forming a gel in the core. Examples of suitable organic peroxides include diacyl peroxides such as, for example, decanoyl peroxide, lauroyl peroxide and benzoyl peroxide, ketone peroxides such as, for example, cyclohexanone peroxide and methyl ethyl ketone, alkyl peroxyesters such as, for example, t-butyl peroxy neodecanoate, 2,5-dimethyl 2,5-di (2-ethyl hexanoyl peroxy) hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, oo-t-butyl o-isopropyl mono peroxy carbonate, 2,5-dimethyl 2,5-di (benzoyl peroxy) hexane, oo-t-butyl o-(2-ethyl hexyl) mono peroxy carbonate, and oo-t-amyl o-(2-ethyl hexyl) mono peroxy carbonate, alkyl peroxides such as, for example, dicumyl peroxide, 2,5-dimethyl 2,5-di (t-butyl peroxy) hexane, t-butyl cumyl peroxide, α-α-bis(t-butyl peroxy) diisopropyl benzene, di-t-butyl peroxide and 2,5-dimethyl 2,5-di (t-butyl peroxy) hexyne-3, alkyl hydroperoxides such as, for example, 2,5-dihydro peroxy 2,5-dimethyl hexane, cumene hydroperoxide, t-butyl hydroperoxide and t-amyl hydroperoxide, and alkyl peroxyketals such as, for example, n-butyl 4,4-di (t-butyl peroxy) valerate, 1,1-di (t-butyl peroxy) 3,3,5-trimethyl cyclohexane, 1,1-di (t-butyl peroxy)cyclohexane, 1,1-di (t-amyl peroxy)cyclohexane, 2,2-di (t-butyl peroxy) butane, ethyl 3,3-di (t-butyl peroxy) butyrate and ethyl 3,3-di (t-amyl peroxy) butyrate, and combinations thereof. Examples of suitable azo compounds include 2,2,′-azobis(2,4-dimethylpentane nitrile), azobis-isobutyronitrile, 2,2′-azobis (isobutyronitrile), 2,2′-azobis (2,4-dimethyl valeronitrile), 2,2′-azobis (methyl butyronitrile), 1,1′-azobis (cyano cyclohexane), other similar known compounds, and combinations thereof.

The crosslinker and amorphous resin may be combined for a sufficient time and at a sufficient temperature to form the crosslinked polyester gel. In embodiments, the crosslinker and amorphous resin may be heated to a temperature of from about 25° C. to about 99° C., in embodiments from about 30° C. to about 95° C., for a period of time of from about 1 minute to about 10 hours, in embodiments from about 5 minutes to about 5 hours, to form a crosslinked polyester resin or polyester gel suitable for use as a shell.

Where utilized, the crosslinker may be present in an amount of from about 0.001% by weight to about 5% by weight of the resin, in embodiments from about 0.01% by weight to about 1% by weight of the resin.

A single polyester resin may be utilized as the shell or, in embodiments, a first polyester resin may be combined with other resins to form a shell. Multiple resins may be utilized in any suitable amounts. In embodiments, a first amorphous polyester resin, for example an amorphous resin of formula I above, may be present in an amount of from about 20 percent by weight to about 100 percent by weight of the total shell resin, in embodiments from about 30 percent by weight to about 90 percent by weight of the total shell resin. Thus, in embodiments, a second resin may be present in the shell resin in an amount of from about 0 percent by weight to about 80 percent by weight of the total shell resin, in embodiments from about 10 percent by weight to about 70 percent by weight of the shell resin.

### Coalescence

Following aggregation to the desired particle size and the optional application of a shell resin described above, the particles may then be coalesced to the desired final shape, the coalescence being achieved by, for example, heating the mixture to a suitable temperature. This temperature may, in embodiments, be from about 0° C. to about 50° C. higher than the onset melting point of the crystalline polyester resin utilized in the core, in other embodiments from about 5° C. to about 30° C. higher than the onset melting point of the crystalline polyester resin utilized in the core. For example, by utilizing the polyester gel in forming a shell as described above, in embodiments the temperature for coalescence may be from about 40° C. to about 99° C., in embodiments from about 50° C. to about 95° C. Higher or lower temperatures may be used, it being understood that the temperature is a function of the resins used.

Coalescence may also be carried out with stirring, for example at a speed of from about 50 rpm to about 1,000 rpm, in embodiments from about 100 rpm to about 600 rpm. Coalescence may be accomplished over a period of from about 1 minute to about 24 hours, in embodiments from about 5 minutes to about 10 hours.

After coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

In embodiments, toners of the present disclosure may be utilized as ultra low melt (ULM) toners. In embodiments, the dry toner particles of the present disclosure may, exclusive of external surface additives, have the following characteristics:

(1) Volume average diameter (also referred to as “volume average particle diameter”) of from about 3 to about 25 μm, in embodiments from about 4 to about 15 μm, in other embodiments from about 5 to about 12 μm.

(2) Number Average Geometric Size Distribution (GSDn) and/or Volume Average Geometric Size Distribution (GSDv) of from about 1.05 to about 1.55, in embodiments from about 1.1 to about 1.4.

(3) Circularity of from about 0.93 to about 1, in embodiments from about 0.95 to about 0.99 (measured with, for example, a Sysmex FPIA 2100 analyzer).

The characteristics of the toner particles may be determined by any suitable technique and apparatus. Volume average particle diameter D₅₀ᵥ, GSDv, and GSDn may be measured by means of a measuring instrument such as a Beckman Coulter Multisizer 3, operated in accordance with the manufacturer's instructions. Representative sampling may occur as follows: a small amount of toner sample, about 1 gram, may be obtained and filtered through a 25 micrometer screen, then put in isotonic solution to obtain a concentration of about 10%, with the sample then run in a Beckman Coulter Multisizer 3.

### Additives

In embodiments a suitable additive may include an additive that has been treated with fluorine. Suitable additives that may be treated with fluorine include, for example, metal oxides such as silica, aluminum oxide, aluminum dioxide, titanium oxide, titanium dioxide, and combinations thereof. In embodiments, the additive may include titanium dioxide that has been treated with fluorine.

Fluorine surface treatments which may be applied to the metal oxides include, for example, a polymer containing one or more fluorine atoms in the monomer unit, a surfactant containing one or more fluorine atoms, a silane containing one or more fluorine atoms, and combinations thereof. Examples include TEFLON® fluorinated ethylene from DuPont, fluorinated ethylene-propylene copolymers, or perfluoroalkoxy copolymers, NEOFLON™ polychlorotrifluoroethylene from Daikin America, Inc., KYNAR®, KYNAR 500® polyvinylidene fluoride from Arkema Inc, KYNAR FLEX®, KYNAR POWERFLEX® copolymers of polyvinylidene fluoride and hexafluoropropylene (HFP) from Arkema Inc., TEFZEL® ethylene tetrafluoroethylene from DuPont, combinations thereof, and the like. Also suitable are low molecular weight fluoropolymers and fluorosurfactants, such as AGC Chemicals Americas, Inc. FLUON®, DuPont ZONYL®, and perfluorooctanesulfonic acid (PFOS), perfluorooctanoic acid (PFOA), and perfluorononanoic acid (PFNA), and perfluorobutanesulfonic acid from 3M. Also suitable are mono-functional and poly-functional fluorosilanes such as FLUOROSYL® available from Cytonix.

Examples of a titanium dioxide that has been treated with fluorine that may be utilized are STT100H-F10 and STT100H-F20, which are commercially available from Titan Kogyo, combinations thereof, and the like.

Fluorinated metal oxides, such as a fluoro treated titanium dioxide, may possess fluorine in amounts of from about 1% by weight of the metal oxide to about 20% by weight of the metal oxide, in embodiments from about 2% by weight of the metal oxide to about 10% by weight of the metal oxide.

In accordance with the present disclosure, fluorinated titanium dioxide may be added in amounts of from about 0.2% by weight to about 3% by weight of the toner, in embodiments from about 0.3% by weight to about 2.5% by weight of the toner.

It has been found that a fluorinated metal oxide may result in toners having a lower impaction rate and a higher blocking resistance. In embodiments, with low melt jetted polyester toner, there was no change in toner cohesion, a measure of additive impaction, observed with aggressive aging with steel shot for up to 30 minutes with the additive package of this disclosure, improved from 10 minutes for the conventional additive package. In embodiments, with an EA ULM polyester toner, onset of blocking failure was 59° C. with the additive package of this disclosure compared to 55° C. with the conventional additive package.

In embodiments, the toner particles may also contain other optional additives, as desired or required. For example, there can be blended with the toner particles external additive particles including flow aid additives, which additives may be present on the surface of the toner particles. Examples of these additives include metal oxides such as titanium oxide, silicon oxide, tin oxide, mixtures thereof, and the like; colloidal and amorphous silicas, such as AEROSIL®, metal salts and metal salts of fatty acids inclusive of zinc stearate, aluminum oxides, cerium oxides, and combinations thereof. In embodiments, these metal oxides and other additives may improve toner relative humidity (RH) sensitivity, as well as flow and blocking properties. These metal oxides may include nano size amorphous particles that also have important functions during printing such as enabling development, and transfer of toner to the substrate.

In embodiments, a silica in combination with zinc stearate may be utilized as an additional additive. In embodiments, a suitable silica may include an alkylsilane treated silica, a fluoroalkyl treated silica, combinations thereof, and the like.

In embodiments, the use of a fluorinated may result in improved charge characteristics, which may permit optimization of toner properties. For example, the use of a fluorinated titania may reduce the amount of silica needed, permitting one to obtain even better relative humidity (RH) performance, as silica has a higher RH sensitivity than the fluorinated titania.

Toners may possess the silica in amounts of from about 0.5% by weight of the toner to about 5% by weight of the toner, in embodiments from about 1% by weight of the toner to about 4% by weight of the toner.

Toners possessing the above additive package, in embodiments the titanium dioxide with the fluoro containing surface treatment and the silica in combination with zinc stearate, may thus possess silicon and titanium in the toner at a ratio of silicon to titanium of from about 0.2:1 to about 3:1, in embodiments from about 0.3:1 to about 2.5:1.

It has been surprisingly found that these additives both increase the blocking temperature of EA ULM toners, from about 55° C. for an EA ULM possessing a conventional additive package, to from about 56° C. to about 60° C., in embodiments from about 58 to about 60° C., in embodiments about 59° C. for a toner with the additive package of the present disclosure. These improvements are very important because they have potential for cost reduction, with lower amounts of additives required based on the more effective silica and fluoro treated titanium dioxide to provide the same blocking performance. Toners particles possessing the fluorinated titania may also exhibit lower impaction of the additives, and low wire contamination in hybrid scavengeless development systems (HSD).

The additive package may be present in an amount of from about 0.1 percent by weight to about 6 percent by weight of the toner, in embodiments of from about 0.25 percent by weight to about 4 percent by weight of the toner.

Toners produced in accordance with the present disclosure may possess excellent charging characteristics when exposed to extreme relative humidity (RH) conditions. The low-humidity zone (C zone) may be about 10° C./15% RH, while the high humidity zone (A zone) may be about 28° C./85% RH. Toners of the present disclosure may possess a parent toner charge per mass ratio (Q/M) of from about −3 μC/g to about −90 μC/g, in embodiments from about −5 μC/g to about −80 μC/g, and a final toner charging of from about −10 μC/g to about −80 μC/g, in embodiments from about −15 μC/g to about −60 μC/g.

In accordance with the present disclosure, the charging of the toner particles may be enhanced, so less surface additives may be required, and the final toner charging may thus be higher to meet machine charging requirements.

For example, the additive packages of the present disclosure may, in embodiments, improve blocking and charging characteristics of the toner particles, including A-zone charging.

### Developers

The toner particles thus obtained may be formulated into a developer composition. The toner particles may be mixed with carrier particles to achieve a two-component developer composition. The toner concentration in the developer may be from about 1% to about 25% by weight of the total weight of the developer, in embodiments from about 2% to about 15% by weight of the total weight of the developer.

### Carriers

Examples of carrier particles that can be utilized for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Other carriers include those disclosed in U.S. Pat. Nos. 3,847,604, 4,937,166, and 4,935,326.

The selected carrier particles can be used with or without a coating. In embodiments, the carrier particles may include a core with a coating thereover which may be formed from a mixture of polymers that are not in close proximity thereto in the triboelectric series. The coating may include fluoropolymers, such as polyvinylidene fluoride resins, terpolymers of styrene, methyl methacrylate, and/or silanes, such as triethoxy silane, tetrafluoroethylenes, other known coatings and the like. For example, coatings containing polyvinylidenefluoride, available, for example, as KYNAR 301F™, and/or polymethylmethacrylate, for example having a weight average molecular weight of about 300,000 to about 350,000, such as commercially available from Soken, may be used. In embodiments, polyvinylidenefluoride and polymethylmethacrylate (PMMA) may be mixed in proportions of from about 30 to about 70 weight % to about 70 to about 30 weight %, in embodiments from about 40 to about 60 weight % to about 60 to about 40 weight %. The coating may have a coating weight of, for example, from about 0.1 to about 5% by weight of the carrier, in embodiments from about 0.5 to about 2% by weight of the carrier.

In embodiments, PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with polymer in an amount from about 0.05 to about 10 percent by weight, in embodiments from about 0.01 percent to about 3 percent by weight, based on the weight of the coated carrier particles, until adherence thereof to the carrier core by mechanical impaction and/or electrostatic attraction.

Various effective suitable means can be used to apply the polymer to the surface of the carrier core particles, for example, cascade roll mixing, tumbling, milling, shaking, electrostatic powder cloud spraying, fluidized bed, electrostatic disc processing, electrostatic curtain, combinations thereof, and the like. The mixture of carrier core particles and polymer may then be heated to enable the polymer to melt and fuse to the carrier core particles. The coated carrier particles may then be cooled and thereafter classified to a desired particle size.

In embodiments, suitable carriers may include a steel core, for example of from about 25 to about 100 μm in size, in embodiments from about 50 to about 75 μm in size, coated with about 0.5% to about 10% by weight, in embodiments from about 0.7% to about 5% by weight, of a conductive polymer mixture including, for example, methylacrylate and carbon black using the process described in U.S. Pat. Nos. 5,236,629 and 5,330,874.

The carrier particles can be mixed with the toner particles in various suitable combinations. The concentrations are may be from about 1% to about 20% by weight of the toner composition. However, different toner and carrier percentages may be used to achieve a developer composition with desired characteristics.

### Imaging

The toners can be utilized for electrostatographic or xerographic processes, including those disclosed in U.S. Pat. No. 4,295,990, the disclosure of which is hereby incorporated by reference in its entirety. In embodiments, any known type of image development system may be used in an image developing device, including, for example, magnetic brush development, jumping single-component development, hybrid scavengeless development (HSD), and the like. These and similar development systems are within the purview of those skilled in the art.

Imaging processes include, for example, preparing an image with a xerographic device including a charging component, an imaging component, a photoconductive component, a developing component, a transfer component, and a fusing component. In embodiments, the development component may include a developer prepared by mixing a carrier with a toner composition described herein. The xerographic device may include a high speed printer, a black and white high speed printer, a color printer, and the like.

Once the image is formed with toners/developers via a suitable image development method such as any one of the aforementioned methods, the image may then be transferred to an image receiving medium such as paper and the like. In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium. In embodiments, the fuser member may be heated to a temperature above the fusing temperature of the toner, for example to temperatures of from about 70° C. to about 160° C., in embodiments from about 80° C. to about 150° C., in other embodiments from about 90° C. to about 140° C., after or during melting onto the image receiving substrate.

In embodiments where the toner resin is crosslinkable, such crosslinking may be accomplished in any suitable manner. For example, the toner resin may be crosslinked during fusing of the toner to the substrate where the toner resin is crosslinkable at the fusing temperature. Crosslinking also may be affected by heating the fused image to a temperature at which the toner resin will be crosslinked, for example in a post-fusing operation. In embodiments, crosslinking may be effected at temperatures of from about 160° C. or less, in embodiments from about 70° C. to about 160° C., in other embodiments from about 80° C. to about 140° C.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

An additive package which included about 3.36 parts per hundred (pph) of a hexamethyldisilazane (HMDS) treated 30 nm silicon dioxide, about 1.93 pph of 40 nm decylsilane treated SMT5103 titanium dioxide available from Tayca, 0.5 pph of zinc stearate type L available from Ferro Corporation, and 0.1 pph of HDK® H2050 silica available from Wacker Chemie AG was utilized as a control. An additive package of the present disclosure included the same components, except the SMT5103 titanium dioxide was replaced by STT100H-F10 titanium dioxide, a fluorinated titanium dioxide, which is commercially available from Titan Kogyo.

The additive packages were added to two toners. The first toner was a base cyan parent toner prepared by melt mixing together 3.8% by weight pigment loading of Pigment Blue 15.3 in a propoxylated bisphenol A fumarate resin having a gel content of about 8% by weight, followed by jetting to form micron size particles with a volume average particle size of 8.3 microns. The second toner was an ultra low melt emulsion aggregation toner (sometimes referred to as the EAULM toner) including an amorphous and crystalline resin. A cyan polyester EA ULM toner was prepared in a 30 gallon reactor (17.5 kg dry theoretical toner) as follows. About 19.7 kg emulsion of a bisphenol-A fumaric acid amorphous resin at 45% solids loading in distilled water, 4.4 kg of styrene-acrylate gel latex at 25% solids loading in distilled water, 6.4 kg of an emulsion of dodecanoic acid, fumaric acid, ethylene glycol crystalline polyester resin at 33% solids loading in distilled water, 0.4 kg surfactant (DOWFAX), and 4.3 kg of the Pigment Cyan 15:3 dispersion at 17% solids loading were charged to the reactor. The slurry pH was adjusted to 3.2 using nitric acid. The slurry was then homogenized while adding an aluminum sulfate solution, including 0.19 kg aluminum sulfate with 5.1 kg of distilled water added over a 20 minute period. After a total of 50 minutes homogenization, the homogenizer was stopped and the slurry in the reactor was heated to begin aggregating the toner particles at a batch temperature of 45° C. During aggregation, particle size measurements were taken and run in a Multisizer Coulter counter. Once at a particle size of 6.34 microns, a shell including the same amorphous emulsion in the core was added to the reactor in an amount of 28% of the initial amount of amorphous resin added, and the reactor was further heated to achieve the final targeted particle size of about 8.3±0.5 microns. The slurry was then pH adjusted using sodium hydroxide and the aggregation step was frozen at a pH of about 7.8.

The process proceeded with the reactor temperature increased to 73° C. Once at 69° C., the pH of the toner slurry was adjusted to pH 6, at which time the toner slurry was held to coalesce the particles until they achieved the target circularity of >0.965 (about 88 minutes). Once coalesced, the toner slurry was cooled, discharged and wet sieved. The final toner particle D50, GSD volume, GSD number and circularity were 7.8 microns, 1.19, 1.25 and 0.967, respectively. The additive packages described above were separately added to about 300 grams of each of the toners with a Fuji Mill blender operating at about 13,500 revolutions per minute (rpm). For developer housing tests, about 300 grams of toner was blended in a 4-liter Henschel mixer for 4 minutes at 3100 rpm.

Toner charging and RH sensitivity were determined for each of the toners as follows: about 2.25 grams of toner was placed in a glass jar containing about 50 grams of XEROX iGen3™ Digital Production Press carrier. The jar with toner and carrier was then conditioned under the desired environmental conditions overnight, A-zone at 28° C. and 85% relative humidity (RH), and C-zone at 10° C. and 15% RH. The jar was placed on a Paint Shaker mixer and shaken for varying amounts of time, from 5 minutes to 60 minutes. (Triboelectric charge of the developer in microcoulomb per gram was then obtained at any of the time points by the total blow-off method at 55 psi air pressure. The general procedure is described in “Handbook of Imaging Materials” Arthur S. Diamond (Ed.), Marcel Dekker, Inc., New York, 2002, page 227.)

The toner charge was also measured using a charge spectrograph. The charged toner was removed from the carrier using a jet of air to entrain the toner into the inlet of the charge spectrograph, where the toner was carried down a 30 cm long column with a laminar flow of air and a perpendicular 100 V/cm electric field. The toner charge (q/d) was measured visually as the midpoint of the toner charge distribution on a porous substrate located at the bottom of the column. The toner charge was reported in millimeters of displacement from the zero line. Calibration showed that a charge displacement of 1 millimeter corresponded to a q/d of 0.092 femto coulombs per micron.

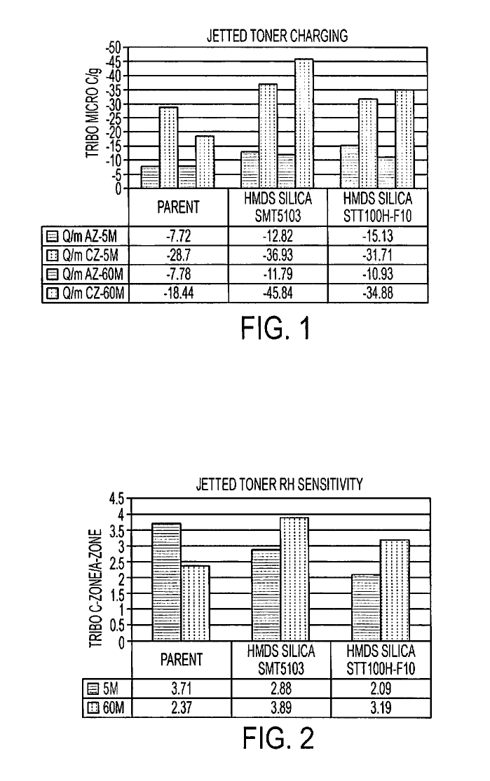

The results are summarized in FIGS. 1 and 2, which shows the toner charging (FIG. 1) and RH sensitivity (FIG. 2) for the first toner with each of the additive packages, the conventional additive package and the additive package of the present disclosure. As can be seen in the figures, the jetted toner charging was more stable with the additive package containing fluorine treated titania, and the RH sensitivity was much reduced with the package including the fluorine treated titania because the fluorine treated surfaces were more hydrophobic. Developer charging at 5 and 60 minutes showed less variation in C zone with the fluorine treated TiO2, showing better stability with mixing time.

Toner blocking resistance was determined by measuring the toner cohesion at elevated temperature above room temperature. Toner blocking measurement was completed as follows: two grams of additive toner was weighed into an open dish and conditioned in an environmental chamber at the specified elevated temperature and 50% relative humidity. After about 17 hours, the samples were removed and acclimated in ambient conditions for about 30 minutes. Each re-acclimated sample was measured by sieving through a stack of two pre-weighed mesh sieves, which were stacked as follows: 1000 μm on top and 106 μm on bottom. The sieves were vibrated for about 90 seconds at 1 mm amplitude with a Hosokawa flow tester. After the vibration was completed, the sieves were reweighed and toner blocking was calculated from the total amount of toner remaining on both sieves as a percentage of the starting weight. Thus, for a 2 gram toner sample, if A was the weight of toner left on the top 1000 μm screen and B was the weight of toner left on the bottom 106 μm screen, the toner blocking percentage was calculated by:

% blocking=50(A+B).

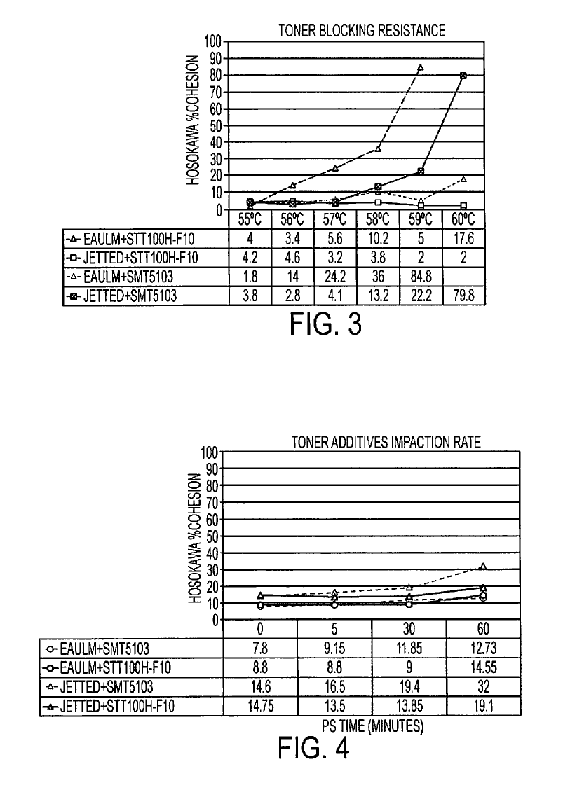

Toner blocking results are set forth in FIG. 3. The toner blocking resistance procedure required that a % cohesion value of 10% or less was achieved after the toner was exposed for a period greater than 10 hours in an oven with 50% RH at elevated temperature. A higher blocking temperature as measured by this test indicated that the toner was robust at these high temperatures, and thus could survive shipment and storage up to that temperature. Also, in long print runs, the temperature inside the developer housing may be severely elevated, so this test measured how high a temperature could be tolerated in the developer housing. As can be seen in FIG. 3, the first, jetted toner with the conventional additives had a blocking resistance of 57° C., and improved to a blocking resistance greater than about 60° C. with the additive package of the present disclosure. The second EA ULM toner with the conventional additives had a blocking resistance of 55° C., which improved to a blocking resistance of about 59° C. with the additive package of the present disclosure.

The surface additive impaction rate for these additive packages was determined by first weighing 40 grams of blended toner and 200 grams of ⅛-inch steel shot into a 250 grams glass bottle, conditioning overnight at 50% RH, and then paint shaken for 5, and 60 minutes. Cohesion was measured using a Hosokawa Micron powder tester with screen sizes of 53 microns, 45 microns and 38 microns, with the larger screen on the top and the smallest screen on the bottom, placing 2 grams of toner on the top screen. The set of screens was vibrated for 90 seconds at 1 mm vibration. The % toner flow cohesion, was calculated by the following formula, where A, B and C were the weight of toner remaining in grams on each of the screens, 53 microns, 45 microns and 38 microns, respectively, where

% Cohesion=50*A+30*B+10*C

The results are set forth in FIG. 4. As can be seen in FIG. 4, the EA ULM toners, with and without the fluorine treated metal oxides, had low additive impaction rate, with only a very small increase in the toner cohesion over 60 minutes. The EA ULM design produced tough particles; therefore the impaction effect of additives was small. However, with the jetted toner after 60 minutes, there was a large effect on the cohesion which increased by a factor of 2 fold compared with the conventional additive package without the fluorine treated titanium dioxide, but showed only a small increase in cohesion with the additive package of the present disclosure with fluorine treated titania dioxide, indicating an improvement in additive impaction with the fluorinated titanium dioxide.

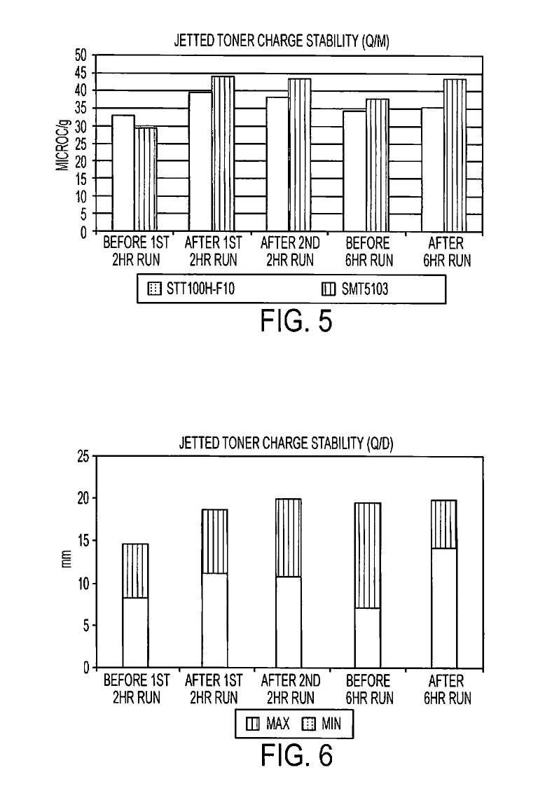

Machine charging and wire contamination performance for the toners was determined by running a developer consisting of 160 grams of toner and 3400 grams of iGen3 carrier in an energized iGen3 developer housing for 10 hours with the initial developer loading and no additional toner throughput. At three time intervals during the test: 2 hours, 4 hours and 10 hours, a sample of developer was taken from the housing and the hybrid scavengeless development (HSD) wires were removed and replaced. Measurement of q/m and q/d charge were performed on the developer samples and the wires were evaluated for material contamination, with the results set forth in FIG. 5. The jetted toner with both additive packages were evaluated in this way. As can be seen in FIG. 5, for the fluorinated titania on the conventional toner, the q/m blow-off charge was stable throughout the test with charge levels almost identical to the conventional additive package.

As shown in FIG. 6, which plots the minimum and maximum q/d from the charge distribution during the test as measured on the charge spectrograph, no wrong sign toner was observed with the fluorinated titania, as the minimum toner charge in the distribution was well above zero charge.

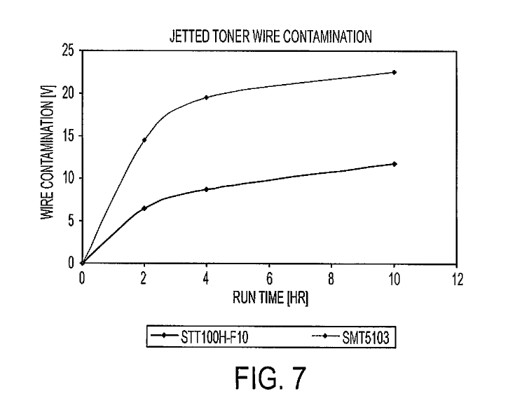

Wire contamination was also measured for the jetted toner for both additive packages. The procedure to measure wire contamination included the following steps. The wire was initially subjected to a series of four compressed air blow-offs at 30 pounds per square inch (psi). The air removed the loose toner particles but left strongly attached contamination on the wire. The wire was then grounded. A high voltage scorotron needle and an electrostatic voltage (ESV) sensor were positioned 2 mm from the wire. While scanning across the wire, the scorotron deposited a charge on the wire. As the wire was grounded, only the charge that was deposited on insulating contamination remained, while the rest dissipated to ground. The ESV sensor measured the residual charge, which corresponded to the amount of insulating contamination present on the wire. The reported ‘wire contamination level’ was the ESV voltage averaged across the length of the wire and added to preceding values. The results are summarized in FIG. 7. As can be seen in FIG. 7, the wire contamination level was much lower for the additive package with fluorinated titania as compared to that measured with the conventional additive package.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A toner comprising:
a resin;
an optional colorant;
an optional wax; and
at least one additive comprising a titanium dioxide treated with fluorine, the fluorine present in an amount of from about 1% by weight of the titanium dioxide to about 20% by weight of the titanium dioxide.

2. The toner according to claim 1, wherein the resin comprises at least one amorphous resin, optionally in combination with at least one crystalline resin.

3. The toner according to claim 1, wherein the resin comprises at least one amorphous polyester resin of the formula: 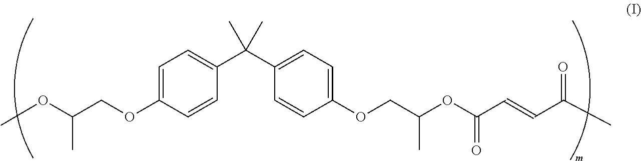
wherein m may be from about 5 to about 1000, in combination with at least one crystalline polyester resin of the formula: 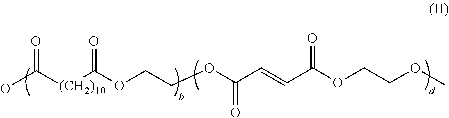
wherein b is from about 5 to about 2000 and d is from about 5 to about 2000.

4. The toner according to claim 1, wherein the optional colorant comprises dyes, pigments, combinations of dyes, combinations of pigments, and combinations of dyes and pigments in an amount of from about 0.1 to about 35 percent by weight of the toner, and wherein the optional wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof, present in an amount from about 1 weight percent to about 25 weight percent of the toner.

5. The toner according to claim 1, wherein the titanium dioxide treated with fluorine is present in an amount of from about 0.2% by weight of the toner to about 3% by weight of the toner.

6. The toner according to claim 1, wherein the at least one additive further comprises silica in combination with a metal salt of a fatty acid.

7. The toner according to claim 6, wherein the silica is present in an amount of from about 0.5% by weight of the toner to about 5% by weight of the toner.

8. The toner according to claim 6, wherein the ratio of silicon to titanium in the toner is from about 0.2:1 to about 3:1.

9. The toner of claim 1, wherein the toner possesses a final charge of from about −10 μC/g to about −80 μC/g at about 85% relative humidity and a temperature of about 28° C.

10. The toner of claim 1, wherein the toner possesses a blocking temperature of from about 56° C. to about 60° C.

11. A toner comprising:
at least one amorphous polyester resin, optionally in combination with at least one crystalline polyester resin;
an optional colorant;
an optional wax; and
at least one additive comprising a titanium dioxide treated with fluorine, the fluorine present in an amount of from about 1% by weight of the titanium dioxide to about 20% by weight of the titanium dioxide, in combination with silica and optionally a metal salt of a fatty acid.

12. The toner according to claim 11, wherein the at least one amorphous polyester resin is of the formula: 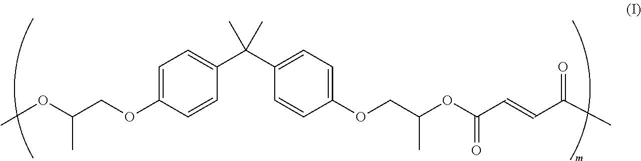
wherein m may be from about 5 to about 1000, and the at least one crystalline polyester resin is of the formula: 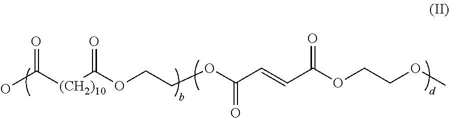
wherein b is from about 5 to about 2000 and d is from about 5 to about 2000.

13. The toner according to claim 11, wherein the optional colorant comprises dyes, pigments, combinations of dyes, combinations of pigments, and combinations of dyes and pigments in an amount of from about 0.1 to about 35 percent by weight of the toner, and wherein the optional wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof, present in an amount from about 1 weight percent to about 25 weight percent of the toner.

14. The toner according to claim 11, wherein the titanium dioxide treated with fluorine is present in an amount of from about 0.2% by weight of the toner to about 3% by weight of the toner, and wherein the silica is present in an amount of from about 0.5% by weight of the toner to about 5% by weight of the toner.

15. The toner according to claim 11, wherein the ratio of silicon to titanium in the toner is from about 0.2:1 to about 3:1.

16. The toner according to claim 11, wherein the silica is selected from the group consisting of alkylsilane treated silica, fluoroalkyl treated silica, and combinations thereof.

17. The toner of claim 11, wherein the toner possesses a final charge of from about −10 to about −80 microcoulombs per gram at about 85% relative humidity and a temperature of about 28° C., and wherein the toner possesses a blocking temperature of from about 56° C. to about 60° C.

18. A toner comprising:
at least one amorphous polyester resin, optionally in combination with at least one crystalline polyester resin;
an optional colorant;
an optional wax; and
at least one additive comprising a titanium dioxide treated with fluorine, the fluorine present in an amount of from about 1% by weight of the titanium dioxide to about 20% by weight of the titanium dioxide, in combination with silica and optionally zinc stearate,
wherein the titanium dioxide treated with fluorine is present in an amount of from about 0.2% by weight of the toner to about 3% by weight of the toner.

19. The toner according to claim 18, wherein the at least one amorphous polyester resin is of the formula: 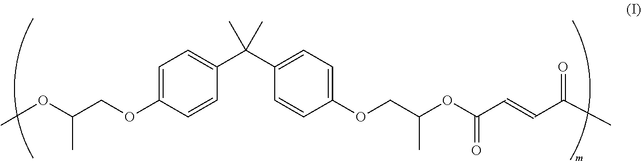
wherein m may be from about 5 to about 1000, and the at least one crystalline polyester resin is of the formula: 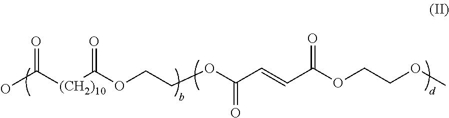
wherein b is from about 5 to about 2000 and d is from about 5 to about 2000.

20. The toner according to claim 18, wherein the ratio of silicon to titanium in the toner is from about 0.2:1 to about 3:1, the toner possesses a final charge of from about −10 to about −80 microcoulombs/gram at about 85% relative humidity and a temperature of about 28° C., and wherein the toner possesses a blocking temperature of from about 56° C. to about 60° C.
